(19) United States
(12) Patent Application Publication
(10) Pub. No.: US 2024/0375535 A1
(43) Pub. Date: Nov. 14, 2024

(54) ELECTRIFIED VEHICLE

(71) Applicant: TOYOTA JIDOSHA KABUSHIKI KAISHA, Toyota-shi (JP)

(72) Inventors: Yutaka KUBOYAMA, Toyota-shi (JP); Akito Motohira, Toyota-shi (JP)

(73) Assignee: TOYOTA JIDOSHA KABUSHIKI KAISHA, Toyota-shi (JP)

(21) Appl. No.: 18/433,928

(22) Filed: Feb. 6, 2024

(30) Foreign Application Priority Data
May 11, 2023 (JP) 2023-078791

(51) Int. Cl. B60L 53/22; B60L 53/62

(52) U.S. Cl. CPC B60L 53/22; B60L 53/62; B60L 2210/12; B60L 2210/14

(57) ABSTRACT

The electrified vehicle includes a power storage device, a connector, a buck-boost converter that exchanges power with voltage conversion between a first power line to which the power storage device is connected and a second power line to which the connector is connected; A charging relay provided on the second power line, and a control device that controls the buck-boost converter and the relay, and the control device is connected to the connector and the external power supply device and before turning on the charging relay. The voltage of the converter side portion of the second power line that is closer to the buck-boost converter than the charging relay is adjusted based on the voltage of the connector side portion of the second power line that is closer to the connector than the charging relay. The buck-boost converter is controlled so that the

### CROSS-REFERENCE TO RELATED APPLICATION

This application claims priority to Japanese Patent Application No. 2023-078791 filed on May 11, 2023, incorporated herein by reference in its entirety.

### BACKGROUND

### 1. Technical Field

The present disclosure relates to an electrified vehicle.

### 2. Description of Related Art

Conventionally, an electrified vehicle has been proposed that includes a power storage device, a connector connected to the power storage device via a power line, and a charging relay provided on the power line (for example, see Japanese Unexamined Patent Application Publication No. 2021-112004 (JP 2021-112004 A)). When connecting the connector of this electrified vehicle and a quick charger, and turning on the charging relay to charge the power storage device from the quick charger, precharging voltage on the quick charger side of the charging relay to voltage on a system main relay side of the charging relay suppresses fusing of the charging relay due to inrush current.

### SUMMARY

In order to use a power storage device with a high rated voltage in the above electrified vehicle, adding a buck-boost converter between the charging relay on the power line and the power storage device is being considered. In such a configuration, there is a need to suppress fusing of the charging relay when the charging relay is turned on.

A main object of the electrified vehicle according to the present disclosure is to suppress fusing of the charging relay when the charging relay is turned on.

In order to achieve the above-described main object, the electrified vehicle of the present disclosure adopts the following measures.
1. An electrified vehicle according to the present disclosure includes
a power storage device,
s connector,
a buck-boost converter that exchanges electric power, accompanied by voltage conversion, with a first power line to which the power storage device is connected and a second power line to which the connector is connected,
a charging relay provided on the second power line, and
a control device that controls the buck-boost converter and the relay.

When the connector and an external power supply device are connected, and before the charging relay is turned on, the control device controls the buck-boost converter such that voltage of a converter-side portion of the second power line that is a portion on the buck-boost converter side from the charging relay is adjusted, based on voltage of a connector-side portion of the second power line that is a portion on the connector side from the charging relay.

In the electrified vehicle according to the present disclosure, when the connector and the external power supply device are connected and before the charging relay is turned on, the buck-boost converter is controlled such that the voltage of the converter-side portion of the second power line that is a portion on the buck-boost converter side from the charging relay is adjusted, based on the voltage of the connector-side portion of the second power line that is a portion on the connector side from the charging relay. By turning the charging relay on when an absolute value of voltage difference, obtained by subtracting the voltage on the converter side portion from the voltage on the connector side portion, is relatively small, fusing of the charging relay at the time of turning the charging relay on can be suppressed.
2. In the electrified vehicle according to the present disclosure (the electrified vehicle according to 1. above), before turning on the relay, the control device may control the buck-boost converter by either or both of feedforward control based on the voltage of the connector-side portion and feedback control for bringing the voltage of the converter-side portion closer to the voltage of the connector-side portion. Thus, the voltage at the converter-side portion can be adjusted by controlling the buck-boost converter using feedforward control or feedback control.
3. In this case (the electrified vehicle according to 2. above), the control device may turn the charging relay on when, before turning on the charging relay, at least one of a condition that an absolute value of voltage difference obtained by subtracting the voltage of the converter-side portion from the voltage of the connector-side portion continues at no more than a difference threshold value over a first predetermined duration of time, and a condition that either or both of the feedforward control and the feedback control continue over a second predetermined duration of time, is satisfied. Thus, fusing of the charging relay when the charging relay is turned on can be further suppressed.
4. In this case (the electrified vehicle according to 3. above), the electrified vehicle may further include
a first voltage sensor that detects the voltage of the connector-side portion, and
a second voltage sensor that detects the voltage of the converter-side portion.

The difference threshold value may be set based on at least one of a permissible upper limit value of the absolute value of the voltage difference, a detection error of the first voltage sensor, a detection error of the second voltage sensor, and a control error of the voltage of the connector-side portion by the external power supply device. Thus, the difference threshold value can be set more appropriately.
5. In the electrified vehicle according to the present disclosure (the electrified vehicle according to any one of 1. to 4. above), when the connector and the external power supply device are connected, the control device controls the buck-boost converter after turning on the charging relay, such that the voltage of the converter-side portion becomes high as compared to before turning on the charging relay, within a range of no more than a permissible upper limit voltage of the external power supply device. Thus, fusing of the charging relay when turning on the charging relay can be suppressed while suppressing increase in costs due to raising withstand voltage of the charging relay, and also charging electric power of the power storage device after turning on the charging relay can be increased to shorten charging time of the power storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 20 of this embodiment and a charging station 80 as an external power supply device;

FIG. 2 is a flowchart showing an example of an external charging control routine executed by vehicle ECU 50; and

FIG. 3 is an explanatory diagram showing an example of a situation when external charging is started.

### DETAILED DESCRIPTION OF EMBODIMENTS

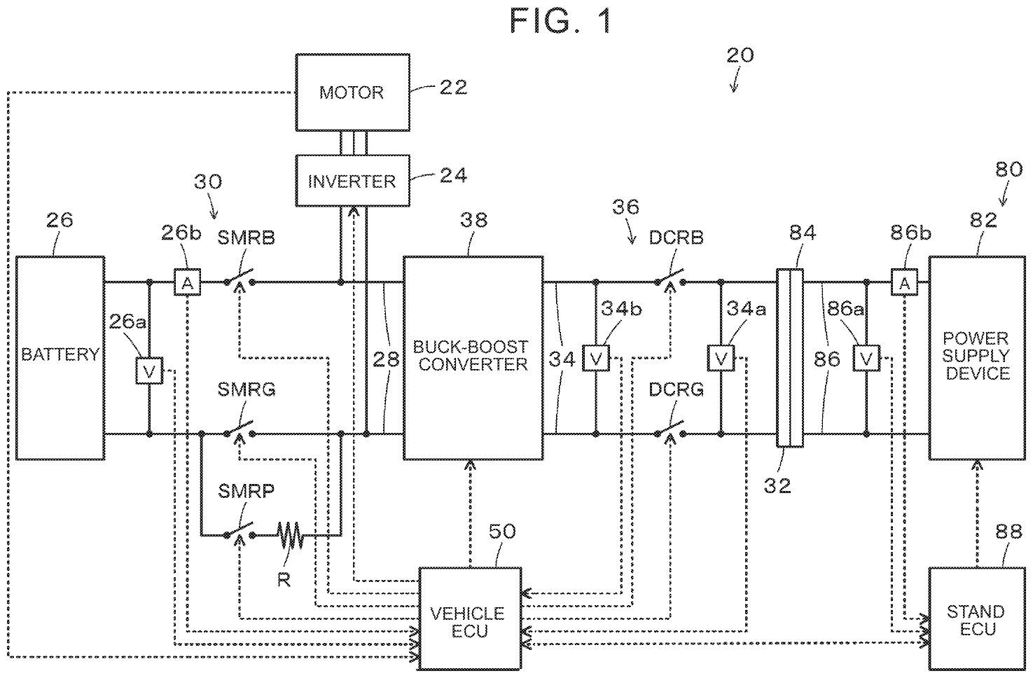

Embodiments of the present disclosure will be described with reference to the drawings. FIG. 1 is a schematic configuration diagram of a battery electric vehicle 20 of this embodiment and a charging station 80 as an external power supply device. As illustrated, the battery electric vehicle 20 includes a motor 22, an inverter 24, a battery 26 as a power storage device, a system main relay 30, a vehicle-side connector 32, a charging relay 36, a buck-boost converter 38, A vehicle electronic control unit (hereinafter referred to as “vehicle ECU”) 50 is provided.

The motor 22 is configured, for example, as a synchronous generator motor. The rotor of the motor 22 is connected to a drive shaft that is connected to drive wheels via a differential gear. Inverter 24 is used to drive motor 22. Further, the inverter 24 is connected to a power line 28 along with a battery 26 and a buck-boost converter 38. The battery 26 is configured as, for example, a lithium ion secondary battery or a nickel hydride secondary battery.

System main relay 30 is provided on power line 28. This system main relay 30 bypasses the positive relay SMRB provided on the positive side line of the power line 28, the negative relay SMRG provided on the negative side line of the power line 28, and the negative relay SMRG. It has a precharge circuit in which a precharge resistance element R and a precharge relay SMRP are connected in series. The system main relay 30 connects and disconnects the inverter 24 or buck-boost converter 38 side and the battery 26 side in the power line 28 by turning on and off.

The vehicle-side connector 32 is configured to be connectable to a stand-side connector 84 of the charging station 80. This vehicle-side connector 32 is connected to the power line 34 together with a buck-boost converter 38. Charging relay 36 is provided on power line 34. The charging relay 36 includes a positive relay DCRB provided on the positive line of the power line 34 and a negative relay DCRG provided on the negative line of the power line 34. The charging relay 36 connects and disconnects the vehicle-side connector 32 side and the buck-boost converter 38 side of the power line 34 by turning on and off.

Buck-boost converter 38 is connected to power line 28 and power line 34. The buck-boost converter 38 is configured as a buck-boost chopper circuit having a plurality of switching elements and a reactor. The buck-boost converter 38 is configured to be able to step up the power on the power line 34 and supply it to the power line 28, or step down the power on the power line 34 and supply it to the power line 28.

Vehicle ECU 50 includes a microcomputer. A microcomputer has a CPU, ROM, RAM, flash memory, input/output ports, and communication ports. The vehicle ECU 50 receives signals from various sensors. For example, the vehicle ECU 50 receives the rotational position θm of the rotor of the motor 22 from a rotational position sensor, and the phase currents Iu, Iv, and Iw of each phase of the motor from a current sensor. The vehicle ECU 50 also receives the voltage VB of the battery 26 from the voltage sensor 26a and the current IB of the battery 26 from the current sensor 26b. Voltage VDC of a portion of the power line 34 from the voltage sensor 34a that is closer to the vehicle side connector 32 than the charging relay 36 (hereinafter referred to as “connector side portion”), or higher than the charging relay 36 of the power line 34 from the voltage sensor 34b. The voltage VL of the part on the buck-boost converter 38 side (hereinafter referred to as “converter side part”) is also input.

Vehicle ECU 50 outputs various control signals. For example, the vehicle ECU 50 sends control signals to the inverter 24, control signals to the system main relay 30 (positive side relay SMRB, negative side relay SMRG, precharge relay SMRP), charging relay 36 (positive side relay DCRB, negative side relay It outputs a control signal to the side relay DCRG) and a control signal to the buck-boost converter 38. The vehicle ECU 50 calculates the storage percentage SOC of the battery 26 based on the current IB of the battery 40. The vehicle ECU 50 can communicate with a stand electronic control unit (hereinafter referred to as “stand ECU”) 88 of the charging station 80 by wire and/or wirelessly at home or at a charging station.

The charging station 80 is installed at home, a charging station, or the like. The charging station 80 includes a power supply device 82, a stand-side connector 84, and a stand ECU 88. The power supply device 82 is connected to the stand side connector 84 via a power line 86. The power supply device 82 is configured to convert alternating current power from the power system into direct current power, and to adjust and output the output voltage and output current. The stand-side connector 84 is configured to be connectable to the vehicle-side connector 32 of the battery electric vehicle 20. When the stand side connector 84 and the vehicle side connector 32 are connected, the power line 86 and the power line 34 are connected.

Stand ECU 88 includes a microcomputer. A microcomputer has a CPU, ROM, RAM, flash memory, input/output ports, and communication ports. The stand ECU 88 receives the output voltage Vs of the power supply device 82 from the voltage sensor 86a and the output current Is of the power supply device 82 from the current sensor 86b. Stand ECU 88 outputs a control signal to power supply device 82. The stand ECU 88 calculates the output power Ps based on the output voltage Vs and the output current Is. The stand ECU 88 can communicate with the vehicle ECU 50 of the battery electric vehicle 20.

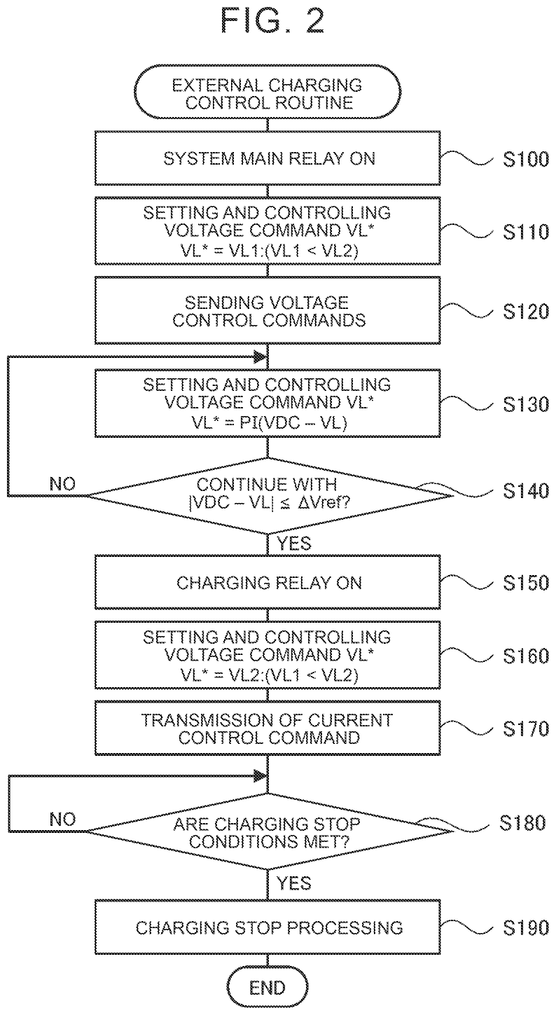

Next, the operation of the battery electric vehicle 20 of this embodiment, particularly the operation during external charging in which the battery 26 is charged using electric power from the charging station 80, will be described. FIG. 2 is a flowchart showing an example of an external charging control routine executed by vehicle ECU 50. This routine is executed when the vehicle-side connector 32 of the battery electric vehicle 20 and the stand-side connector 84 of the charging station 80 are connected at home or at a charging station, and charging start conditions are satisfied. As the charging start condition, for example, an OR condition such as a condition in which a user instructs to start charging the battery 40 or a condition in which a charging start time is reached based on a scheduled departure time set by the user is used.

When the external charging control routine of FIG. 2 is executed, the vehicle ECU 50 first turns on the system main relay 30 (S100), sets the voltage command VL* of the converter side portion to the voltage VL1, and sets the voltage command VL* is used to control the buck-boost converter 38 (S110). Here, a relatively low voltage, for example, a voltage obtained by adding a margin to the allowable lower limit voltage of the power supply device 82, is used as the voltage VL1. The buck-boost converter 38 is controlled by, for example, setting the duty of a plurality of switching elements of the buck-boost converter 38 based on the value obtained by dividing the voltage command VL* by the voltage VB of the battery 26, and using the set duty to control the plurality of switching elements. This is done by controlling the switching of switching elements. The duty corresponds to the step-down ratio of the buck-boost converter 38.

Subsequently, vehicle ECU 50 transmits a voltage control command to stand ECU 88 (S120). Upon receiving the voltage control command, the stand ECU 88 controls the power supply device 82 so that the output voltage Vs of the power supply device 82 becomes the target voltage Vs*. As a result, the voltage VDC of the converter side portion becomes approximately the target voltage Vs*. Here, as the target voltage Vs*, a relatively low voltage within the allowable voltage range of the power supply device 82, for example, a voltage near the voltage VL1, is used.

Then, the voltage command VL* of the converter side part is calculated by equation (1) using the voltage VDC of the connector side part, the voltage VL of the converter side part, and the previous voltage command (previous VL*), and the calculated converter side The buck-boost converter 38 is controlled using the partial voltage command VL* (S130). Here, Equation (1) is a relational expression in voltage feedback control for bringing the voltage VL of the converter side portion closer to the voltage VDC of the connector side portion. In equation (1), the second term on the right side is a proportional term in voltage feedback control, and “kp” is the gain of the proportional term.

VL*=Previous VL*+kp·(VDC−VL) (1)

Next, it is determined whether the absolute value of the voltage difference ΔV (=VDC−VL) obtained by subtracting the voltage VL of the converter side part from the voltage VDC of the connector side part remains below the threshold value ΔVref for a predetermined time T1. is determined (S140). Here, the threshold value ΔVref is a threshold value used to determine whether the voltage VDC of the connector side portion and the voltage VL of the converter side portion are sufficiently close to each other. The threshold value ΔVref is determined from among the allowable upper limit value ΔVmax of the absolute value of the voltage difference ΔV, the detection error sa of the voltage sensor 34a, the detection error ab of the voltage sensor 34b, and the control error sc of the voltage VDC of the connector side portion by the power supply device 82. The setting is based on at least one of the following. For example, the threshold value ΔVref is calculated from the allowable upper limit value ΔVmax of the absolute value of the voltage difference ΔV, the detection error sa of the voltage sensor 34a, the detection error ab of the voltage sensor 34b, and the voltage VL of the converter side portion that occurs due to control of the buck-boost converter 38. The upper limit value is the value obtained by subtracting the ripple Rvl and the margin β1 (ΔVmax−εa−εb−Rv−β1), the lower limit value is the margin β2, and the value is set within the range between the upper limit value and the lower limit value. The margins β1 and β2 are the ripple Rvdc of the output voltage Vs and the voltage VDC of the connector side portion that occurs due to the control of the power supply device 82, and the period when the absolute value of the voltage difference ΔV is equal to or less than the threshold value ΔVref in S140 for a predetermined time T1. It is determined by taking into account expected changes in the voltage VDC of the connector side portion and the voltage VL of the converter side portion during the delay time from when it is determined that the charge continues until the charging relay 36 is turned on. The predetermined time T1 is defined as a time period during which it can be determined (determined) that the absolute value of the voltage difference ΔV is equal to or less than the threshold value ΔVref.

When it is determined in S140 that the absolute value of the voltage difference ΔV is larger than the threshold value ΔVref, or when it is determined that the absolute value of the voltage difference ΔV is less than or equal to the threshold value ΔVref but has not continued for the predetermined time T1, the process proceeds to S130. Return to

When it is determined in S140 that the absolute value of the voltage difference ΔV is equal to or less than the threshold value ΔVref and continues for the predetermined time T1, the charging relay 36 is turned on (S150). That is, in this embodiment, the charging relay 36 is turned on when the voltage VDC of the connector side portion and the voltage VL of the converter side portion are sufficiently close to each other. Thereby, it is possible to suppress welding of the charging relay 36 when the charging relay 36 is turned on. Note that by setting the threshold value ΔVref to a relatively small value within the above-mentioned upper and lower limit values, welding of the charging relay 36 can be suppressed more fully.

When the charging relay 36 is turned on in this way, the voltage VL2 is set to the voltage command VL* of the converter side part, the buck-boost converter 38 is controlled using the set voltage command VL* (S160), and the current control command is set to standstill. It is transmitted to ECU 88 (S170). Here, the voltage VL2 is a voltage higher than the voltage VL1 or the voltage VDC1 to some extent, for example, a voltage obtained by subtracting a margin from the allowable upper limit voltage of the power supply device 82. Upon receiving the current control command, the stand ECU 88 controls the power supply device 82 so that the output current Is of the power supply device 82 becomes the target current Is*. As a result, the current flowing through the power line 34 becomes approximately the target current Is*. Here, the target current Is* may be a predetermined constant value, or may be determined based on the specifications of the battery electric vehicle 20, such as the rated current of the power line 34.

By controlling the buck-boost converter 38 and the power supply device 82, the power from the power supply device 82 is supplied to the battery 26 via the power line 86, the stand-side connector 84, the vehicle-side connector 32, the power line 34, the buck-boost converter 38, and the power line 28, and the battery 26 is charged. In this embodiment, the voltage of the power line 34 is made higher after the charging relay 36 is turned on than before the charging relay 36 is turned on, thereby increasing the power of the power line 34 and the charging power of the battery 26. Therefore, the charging time of the battery 26 can be shortened. In addition, by lowering the voltage on the connector side and converter side before turning on the charging relay 36 compared to after turning on the charging relay 36, cost increases due to increased withstand voltage of the charging relay 36 can be suppressed. At the same time, it is possible to suppress welding of the charging relay 36 when the charging relay 36 is turned on.

In this way, while charging the battery 26 using the power from the power supply device 82, it is determined whether or not the charging stop condition is satisfied, thereby waiting for the charging stop condition to be satisfied (S180). Here, as the charging stop condition, for example, an OR condition is used, such as a condition in which the storage percentage SOC of the battery 26 reaches a threshold value Sth or more, a condition in which the user instructs to stop charging the battery 26, or the like.

If it is determined in S180 that the charging stop condition is satisfied, vehicle ECU 50 executes charging stop processing (S190) and ends this routine. Here, in the charging stop process, vehicle ECU 50 stops buck-boost converter 38 and transmits a charge stop command to stand ECU 88. When the stand ECU 88 receives the charging stop command, it stops the power supply device 82. Thereafter, vehicle ECU 50 turns off charging relay 36 and turns off system main relay 30.

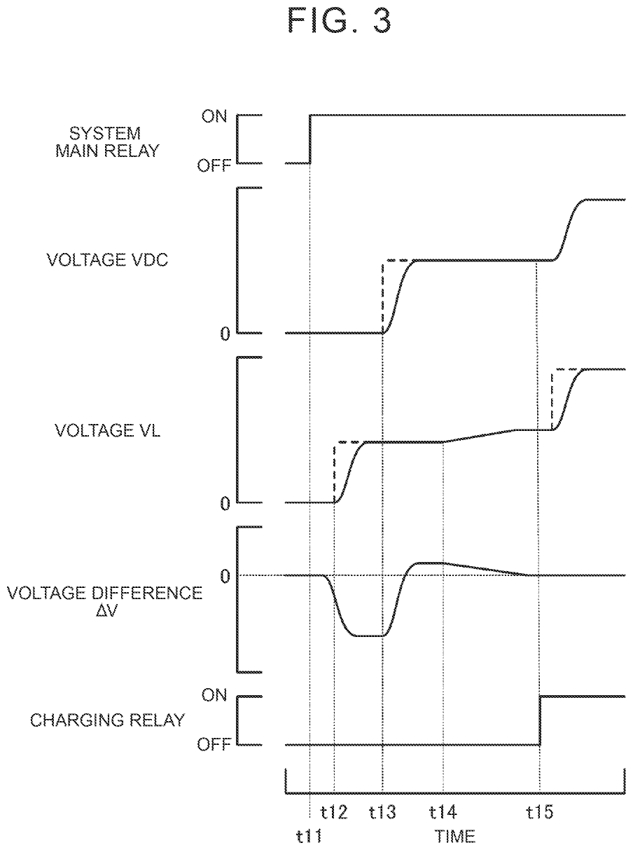

FIG. 3 is an explanatory diagram showing an example of a situation when external charging is started. As shown in the figure, when the vehicle ECU 50 turns on the system main relay 30 (time t11), sets the voltage command VL* of the converter side portion to voltage VL1, and starts controlling the buck-boost converter 38 (time t12), the voltage difference ΔV (=VDC-VL) increases on the negative side. Subsequently, when the stand ECU 88 sets the voltage VDC1 to the voltage command VDC* of the connector side portion and starts controlling the power supply device 82 (time t13), the voltage difference ΔV changes. Then, the vehicle ECU 50 starts controlling the buck-boost converter 38 by feedback control (time t14), and when the absolute value of the voltage difference ΔV continues for a predetermined time T1 below the threshold value ΔVref (time t15), the charging relay is activated. Turn on 36. Thereby, it is possible to suppress welding of the charging relay 36 when the charging relay 36 is turned on. After that, the vehicle ECU 50 sets the voltage command VL* of the converter side portion to a voltage VL2 higher than the voltage VL1 to control the buck-boost converter 38, and the stand ECU 88 controls the power supply device 82 by current control. Through such control, the battery 26 is charged.

In the battery electric vehicle 20 of the present embodiment described above, the voltage command VL* of the converter side part is set by feedback control based on the voltage VL of the converter side part and the voltage VDC of the connector side part, and the buck-boost converter 38 is controlled. However, if the absolute value of the voltage difference ΔV (=VDC−VL) remains below the threshold value ΔVref for a predetermined time T1, the charging relay 36 is turned on. Thereby, it is possible to suppress welding of the charging relay 36 when the charging relay 36 is turned on.

In the embodiment described above, before turning on the charging relay 36, the vehicle ECU 50 calculates the voltage command VL* of the converter side part by voltage feedback control using a proportional term, as shown in equation (1). However, the voltage command VL* may be calculated by voltage feedback control in which an integral term or a differential term is added to the proportional term. In addition, instead of equation (1), when the voltage VL of the converter side part is equal to the voltage VDC of the connector side part, the previous voltage command (previous VL*) is set to a new voltage command VL*, and the converter side part When the voltage VL of the connector side portion is higher than the voltage VDC of the connector side portion, the value obtained by subtracting the predetermined voltage a from the previous voltage command (previous VL*) is set as the new voltage command VL*, and the voltage VL of the converter side portion is When the voltage of the connector side portion is less than VDC, a value obtained by adding a predetermined voltage a to the previous voltage command (previous VL*) may be set as the new voltage command VL*.

In the embodiment described above, before turning on the charging relay 36, the voltage command VL* of the converter side portion is calculated by voltage feedback control as shown in equation (1). However, in addition to or in place of the voltage feedback control, the voltage command VL* may be calculated by voltage feedforward control. In this case, the voltage VDC of the connector side portion, for example, may be used as the feedforward term.

In the embodiment described above, it is assumed that control of the buck-boost converter 38 by voltage feedback control is started, when the voltage command VL* of the converter side portion is set to voltage VL1 to control the buck-boost converter 38, and the voltage command VDC* of the connector side portion is set to voltage VDC1 to control the power supply device 82. However, control of the buck-boost converter 38 by voltage feedback control may be started after waiting for the voltage VDC on the connector side to become stable. Here, the determination as to whether or not the voltage VDC of the connector side portion is stable is determined by, for example, the value obtained by subtracting the minimum value from the maximum value of the voltage VDC of the connector side portion in a predetermined period, that is, the fluctuation F1 of the voltage VDC. This can be done by determining whether it is equal to or less than the threshold value F1ref. When starting to control the buck-boost converter 38 using voltage feedforward control instead of controlling the buck-boost converter 38 using voltage feedback control, or when starting controlling the buck-boost converter 38 using voltage feedforward control and voltage feedback control. You can think about it in the same way.

In the embodiment described above, the charging relay 36 is turned on when the voltage difference ΔV remains below the threshold value ΔVref for a predetermined time T1 while controlling the buck-boost converter 38 by voltage feedback control. did. However, charging relay 36 may be turned on while control of buck-boost converter 38 by voltage feedback control continues for a predetermined time T2. Here, the predetermined time T2 is defined as a time period during which it can be determined (estimated) that the voltage difference ΔV is equal to or less than the threshold value ΔVref. Instead of controlling the buck-boost converter 38 using voltage feedback control, the buck-boost converter 38 is controlled using voltage feedforward control, or when the buck-boost converter 38 is controlled using voltage feedforward control and voltage feedback control. The same can be said for the case where there are. Further, the value obtained by subtracting the minimum value from the maximum value in a predetermined period of the value (VDC-VL) obtained by subtracting the voltage VL of the converter side part from the voltage VDC of the connector part, that is, the fluctuation F2 of the value (VDC-VL) is the threshold. The charging relay 36 may be turned on when the temperature is below F2ref.

In the embodiment described above, after the charging relay 36 is turned on, the voltage command VL* of the converter side portion is lower than or equal to the allowable upper limit voltage of the power supply device 82 compared to before the charging relay 36 is turned on. The buck-boost converter 38 is controlled by increasing the voltage. However, the voltage command VL* of the converter side portion may be made substantially the same before and after turning on the charging relay 36.

In the embodiment described above, the battery 26 is used as the power storage device. However, instead of this, a capacitor or the like may be used.

In the embodiment described above, the battery electric vehicle 20 includes a motor 22. However, it may also be a hybrid electric vehicle that includes an engine in addition to the motor 22, or a fuel cell electric vehicle that includes a fuel cell in addition to the motor 22.

The correspondence between the main elements of the embodiment and the main elements of the disclosure described in the section of means for solving the problems will be explained. In the embodiment, the battery 26 corresponds to a “power storage device,” the vehicle-side connector 32 corresponds to a “connector,” the buck-boost converter 38 corresponds to a “buck-boost converter,” and the charging relay 36 corresponds to a “charging relay.” The vehicle ECU 50 corresponds to the “control device.”

Note that the correspondence between the main elements of the embodiment and the main elements of the disclosure described in the column of means for solving the problem is that the embodiment implements the disclosure described in the column of means for solving the problem. Since this is an example for specifically explaining a form for solving the problem, it is not intended to limit the elements of the disclosure described in the column of means for solving the problems. In other words, the interpretation of the disclosure described in the column of means for solving the problem should be made based on the description in that column, and the embodiments should be based on the description of the disclosure described in the column of means for solving the problem. This is just one specific example.

Although embodiments for implementing the present disclosure have been described above, the present disclosure is not limited to these embodiments in any way, and may be implemented in various forms without departing from the gist of the present disclosure. Of course.

The present disclosure can be used in the electrified vehicle manufacturing industry, etc.

What is claimed is:

1. An electrified vehicle comprising:
a power storage device;
a connector;
a buck-boost converter that exchanges electric power, accompanied by voltage conversion, with a first power line to which the power storage device is connected and a second power line to which the connector is connected;
a charging relay provided on the second power line; and
a control device that controls the buck-boost converter and the relay, wherein, when the connector and an external power supply device are connected, and before the charging relay is turned on, the control device controls the buck-boost converter such that voltage of a converter-side portion of the second power line that is a portion on the buck-boost converter side from the charging relay is adjusted, based on voltage of a connector-side portion of the second power line that is a portion on the connector side from the charging relay.

2. The electrified vehicle according to claim 1, wherein, before turning on the relay, the control device controls the buck-boost converter by either or both of feedforward control based on the voltage of the connector-side portion and feedback control for bringing the voltage of the converter-side portion closer to the voltage of the connector-side portion.

3. The electrified vehicle according to claim 2, wherein the control device turns the charging relay on when, before turning on the charging relay, at least one of a condition that an absolute value of voltage difference obtained by subtracting the voltage of the converter-side portion from the voltage of the connector-side portion continues at no more than a difference threshold value over a first predetermined duration of time, and a condition that either or both of the feedforward control and the feedback control continue over a second predetermined duration of time, is satisfied.

4. The electrified vehicle according to claim 3, further comprising:
a first voltage sensor that detects the voltage of the connector-side portion; and
a second voltage sensor that detects the voltage of the converter-side portion, wherein the difference threshold value is set based on at least one of a permissible upper limit value of the absolute value of the voltage difference, a detection error of the first voltage sensor, a detection error of the second voltage sensor, and a control error of the voltage of the connector-side portion by the external power supply device.

5. The electrified vehicle according to claim 1, wherein, when the connector and the external power supply device are connected, the control device controls the buck-boost converter after turning on the charging relay, such that the voltage of the converter-side portion becomes high as compared to before turning on the charging relay, within a range of no more than a permissible upper limit voltage of the external power supply device.
